(19) United States
(12) Patent Application Publication
(10) Pub. No.: US 2018/0289039 A1
(43) Pub. Date: Oct. 11, 2018

(54) METHODS OF FEEDING YOUNG ANIMALS SOLUBLE MANNAN OLIGOSACCHARIDE-CONTAINING STARTER FEED

(71) Applicant: PURINA ANIMAL NUTRITION LLC, Shoreview, MN (US)

(72) Inventor: Bill L. Miller, Labadie, MO (US)

(21) Appl. No.: 15/480,950

(22) Filed: Apr. 6, 2017

(51) Int. Cl. A23K 20/00; A23K 20/163; A23K 50/60; A23K 10/30

(52) U.S. Cl. CPC A23K 20/00; A23K 20/163; A23K 50/75; A23K 10/30; A23K 50/60

(57) ABSTRACT

Methods involve feeding young livestock animals a starter feed, where the starter feed comprises an amount of soluble mannan oligosaccharides. The young animals may be chicks. In response to ingesting the starter feed, the young animals may increase a rate of weight gain and increase feed efficiency.

### TECHNICAL FIELD

The present disclosure relates to feed products for young livestock animals and methods of feeding such feed products. More particularly, implementations provide methods of feeding starter feeds with soluble mannan oligosaccharides to young animals resulting in improved animal performance.

### BACKGROUND

Young animals require adequate nutrition for healthy growth and development. Robust growth is especially important for livestock animals, which are a commodity raised to produce food products including milk and meat. The time it takes livestock to mature, particularly to gain weight, is important when assessing whether the animal is ready to produce milk or is ready to go to market. A number of feeding systems have been used to enhance weight gain of livestock beginning at a young age. Many of these feeding systems include provision of a solid starter feed as the exclusive source of nutrients, for instance post-weaning, or as one component of a diet, for instance pre-weaning. Starter feeds provide needed protein, fat, fiber, and carbohydrates to developing young animals. Providing nutrients to young mammals through starter feeds may, for example, reduce the age of freshening or the onset of lactation of a dairy cow, thereby reducing the cost of milk production. Increased weight gain of livestock from an early age by ingestion of starter feed may also reduce the cost of beef or poultry production.

A concern for producers is whether livestock animals are receiving adequate nutrients. Because the effects of poor nutrition can be exacerbated at a young age, ensuring that young livestock animals are provided with the necessary nutritive sources is especially important. Differences in feed intake by animals impact the rate of weight gain and ultimately body size. Additionally, the ingestion of adequate nutrients does not guarantee that livestock animals will ultimately receive the benefit of these nutrients, as harmful bacteria residing within the gastrointestinal tract can prevent their absorption through the intestinal wall and into the bloodstream. The microflora imbalance resulting from colonization and aggregation of these bacteria may trigger many conditions that may include colibacillosis, rota virus, corona virus, clostridium perfringens, cryptosporidiosis, coccidosis, and/or septicemia. A wide range of symptoms, such as scours, intestinal lesions, and/or enteritis, may accompany these afflictions, impeding nutrient uptake, decreasing feed intake, and preventing the healthy maturation of intestinal microflora. In light of these conditions and because smaller and/or unhealthy animals are more difficult to adequately manage due to their specific housing, dietary, and husbandry needs, maintaining an intestinal environment conducive to nutrient uptake can be critical to the health and development of young livestock animals.

Work to determine the proper components of starter feeds has been conducted during the last several decades. One result of this work is the widespread use of antibiotics to combat harmful bacteria in the intestine, but frequent antibiotic treatment can lead to bacterial resistance. New approaches to ridding the intestinal lumen of bacterial strains detrimental to healthy growth and development in livestock animals are therefore highly desired.

### SUMMARY

Implementations disclosed herein provide methods of feeding a solid starter feeds with soluble mannan oligosaccharides to young livestock animals.

In various implementations and alternatives, the animals may increase a rate of weight gain, increase feed efficiency, and/or decrease instances of death in response to ingesting the starter feed with soluble mannan oligosaccharides.

In various implementations and alternatives, the animals are chicks. In such cases, the starter feed may include 0.01 to about 1.0 percent soluble mannan oligosaccharides. The chicks may consume between about 0.01 to about 1 gram of the soluble mannan oligosaccharides per day. The chicks may consume about 0.5 to about 1.5 grams of starter feed per day.

In additional implementations and alternatives, the mannan oligosaccharides are extracted from a yeast cell wall. In such cases, the yeast may be a species selected from a group of fungal genera including Paecilomyces, Saccharomyces, and/or Ganoderma.

In addition or alternatively, the soluble mannan oligosaccharides are phosphorylated.

In another implementation, a method of feeding a starter feed to chicks is provided, where the starter feed includes an amount of soluble mannan oligosaccharides and the chicks are between about 0 and about 3 weeks of age. In response to ingesting the starter feed that includes soluble mannan oligosaccharides, the chicks increase a rate of weight gain.

In various implementations and alternatives, the starter feed may include 0.01 to about 1.0 percent soluble mannan oligosaccharides. The chicks may consume between about 0.01 to about 1 gram of the soluble mannan oligosaccharides per day. The chicks may consume about 0.5 to about 1.5 grams of starter feed per day.

### DETAILED DESCRIPTION

Establishing and maintaining a healthy intestinal microbiome helps prevent gastrointestinal disease and facilitates adequate nutrient uptake. Harmful bacteria present in the intestine may disrupt a healthy, balanced microbiome by accumulating in large numbers. More specifically, pathogenic bacteria often bind the mucosa and/or epithelial cells that comprise the inner intestinal wall by means of small, hair-like projections on their surfaces known as pili or fimbriae. These projections are rich in lectins, which are carbohydrate-binding proteins. Because lectins bind specific carbohydrate molecules, bacteria with mannose-specific pili bind intestinal epithelial cells with mannose molecules at their surface. Attachment of pathogens at the epithelial layer can lead to pathogenic colonization, subsequently causing disease.

By providing a mannose molecule that binds to mannose-specific pathogens, mannan oligosaccharides offer a potential means to combat bacterial colonization and infection by sequestering pathogens that might otherwise attach to the intestinal wall. Mannan oligosaccharides are glucomannoprotein molecules derived from the outer portion of fungal cell walls and capable of binding mycotoxins. Mannan oligosaccharides are also resistant to enzymatic digestion in the gut, enabling them to pass through the intestinal tract while towing any bacterial cells they are able to bind. Additionally, mannan oligosaccharides may elicit an immune response by stimulating the secretion of mannose-binding proteins from the liver. These proteins bind bacteria in the intestine, which initiates an immune cascade that not only responds to foreign bacteria, but also fortifies the existing immune system. Although their natural affinity for bacterial pathogens makes them an attractive starter feed additive for young livestock animals, the effectiveness of mannan oligosaccharides to improve animal performance remains limited.

Applicant's discovery of methods of feeding starter feed products that result in increased animal performance is the surprising result of experimentation with various forms of mannan oligosaccharide supplements. Applicant understood that mannan oligosaccharides were capable of binding harmful bacteria in the intestine of young livestock animals, but the inefficiency of this binding prevented a more robust improvement of intestinal microflora. More specifically, the ability of mannan oligosaccharides to bind bacteria remained physically hindered by extraneous cell wall components not removed during their isolation from fungal cell walls, which are comprised of approximately 30 to 60 percent polysaccharides, about 15 to 30 percent proteins, and about 5 to 20 percent lipids. These cell wall components also inhibited mannan oligosaccharides from acting as a substrate for beneficial bacteria, such as bifidobacteria and lactobacillus, which prevented the beneficial bacteria from out-competing the pathogenic strains present in the gut. Accordingly, Applicant endeavored to develop a new method of feeding young livestock animals starter feed products supplemented with more precisely-extracted mannan oligosaccharides that results in improved animal performance. Provided herein are methods of feeding starter feed products comprised of soluble mannan oligosaccharide products. By readily dispersing within the intestinal tract and agglutinating a greater number of bacteria, while also fostering the growth of favorable microbes, the solubility of the mannan oligosaccharides provided to young livestock animals according to the feeding methods herein leads to observed increases in weight gain, rate of weight gain, and feed efficiency and decreases in death loss.

The products and methods of the present disclosure are applicable to young livestock animals including, but not limited to, bunnies, calves, chicks, foals, kids, lambs, and piglets. Depending on the species, the young animals may commence consumption of starter feeds immediately after birth or may not start until a number of weeks after birth. The animals may continue on starter feeds for a length of time that is also species-specific. For example, calves may consume starter feed through weaning, which may occur after about 12 weeks from birth. As another example, chicks for egg-production may consume starter feed for the first about 8 to about 17 weeks of life. As another example, broiler chicks may consume starter feed for the first about 6 to about 8 weeks of life. As another example, lambs may consume starter feed for the first about 1 to about 8 weeks of life. Over this time, the young animal grows and generally increases consumption over time. Some increased consumption is expected, however, implementations of the present invention provide for methods that increase consumption of animal feed containing soluble mannan oligosaccharides compared to other animals of the same age and species when offered the animal feed without the soluble mannan oligosaccharides.

The proportion of starter feed in the diet of young animals may decrease over time. For example, the proportion of starter feed in the diet of chicks for egg production may decrease from about 100 percent at birth to 0 percent by about 17 weeks of life. However, over this time for young animals that are known to decrease consumption over time, the decreased consumption may be relatively reduced so that the animal ingests more feed when ingesting the animal feed containing soluble mannan oligosaccharides compared to other animals of the same age and species when offered the animal feed without the soluble mannan oligosaccharides.

The amount of starter feed consumed by an animal may increase during certain time periods, such as during the growth phase. During a period of increased overall feed consumption, the amount of starter feed consumed by an animal may also increase. The increased consumption of starter feed may occur even while the proportion of starter feed in the animal's diet is decreasing.

Starter Feed Compositions Containing Soluble Mannan Oligosaccharides

Starter feeds of the present disclosure may include or be admixed with soluble mannan oligosaccharides.

Sources of mannan oligosaccharides may include, but are not limited to, eukaryotic cell walls derived from species of fungi that may belong to the Paecilomyces, Saccharomyces, and/or Ganoderma genus. In one embodiment, eukaryotic cells walls are derived from a single species of fungus. In one embodiment, eukaryotic cell walls are derived from Saccharomyces cerevisiae. In other embodiments, eukaryotic cell walls are derived from two or more fungal species. The incorporation of cell walls derived from multiple fungal species in a single composition may result in a synergistic effect by increasing the diversity of bacterial binding sites present on the mannan oligosaccharides.

The mannan oligosaccharides used according to the methods disclosed herein are soluble. As used herein, the term “soluble” means that the mannan oligosaccharides may be totally or at least partially dissolved in water. The solubility of the mannan oligosaccharides used herein results from their enhanced differentiation and purification from the fungal cell walls used to derive them. Alternatively or additionally, “soluble” means that the mannan oligosaccharides may be or totally or at least partially dissociated from the fungal cell walls used to derive them The dissociation may lead to increased suspension or dissolution in water. The concentration of soluble mannan oligosaccharides may be greater relative to preexisting feed additive products. In some embodiments, a totally-soluble mannan oligosaccharide composition may be used. Totally-soluble compositions may be 100 percent soluble and may be produced by isolating pure mannan oligosaccharide, which is free of, or has substantially reduced levels of, unwanted fungal cell wall components such as β-glucans, glucose, protein, nitrogen, and/or fat. In some embodiments a partially-soluble mannan oligosaccharide composition may be used. Partially-soluble compositions may be produced by mixing totally-soluble mannan oligosaccharides with insoluble mannan oligosaccharides. Alternatively, partially-soluble mannan oligosaccharides may be produced by manufacturing processes that partially separate the mannan oligosaccharides from the cell wall. Partially-soluble compositions may be about 30 to about 99 percent, about 50 to about 90 percent, about 55 to about 80 percent, or about 58 to about 70 percent soluble, suspendable, or dissolvable in water.

The mannan oligosaccharide content of the starter feed may vary and may be adjusted according to the needs and/or condition of the animal. Levels may also vary depending on the solubility desired, e.g., whether totally-soluble or partially-soluble mannan oligosaccharide compositions are desired.

In some embodiments, the soluble (e.g., totally-soluble or partially-soluble) mannan oligosaccharides present within the starter feed may comprise about 0.01 to about 1.0 percent, about 0.01 to about 0.5 percent, about 0.01 to about 0.25 percent, about 0.01 to about 0.1 percent, about 0.02 percent to about 1.0 percent, about 0.03 percent to about 1.0 percent, or about 0.05 to about 1.0 percent by weight of the starter feed. For example, about 1 pound of soluble mannan oligosaccharides may be included in a 2000-pound batch of starter feed, or about 2 pounds of soluble mannan oligosaccharides may be included in a 2000-pound batch of starter feed, or about 3 pounds of soluble mannan oligosaccharides may be included in a 2000-pound batch of starter feed. In some examples the soluble mannan oligosaccharide may be included in the starter feed at about 0.05 grams to about 0.45 gram, about 0.05 grams to about 0.4 grams, about 0.05 grams to about 0.35 grams, about 0.1 grams to about 0.3 grams, or about 0.15 grams to about 0.3 grams per pound of starter feed.

Soluble mannan oligosaccharide additives may be provided in powder form. The powder may comprise various amounts of soluble mannan oligosaccharides depending on the process used to derive them. In one embodiment, partially-soluble mannan oligosaccharides may be provided as a concentrated yeast cell wall product. Partially-soluble mannan oligosaccharides may be present in a concentrated yeast cell wall product at about 50 to about 80 percent, about 55 to about 70 percent, about 60 to about 66 percent, or about 62 to about 66 percent by weight of the concentrated yeast cell wall product, with the remaining portion of the product composed of fungal cell wall constituents. The remaining fungal cell wall constituents may include, but are not limited to: glucose, nitrogen, protein, ash, fat, and β-glucan molecules. In another embodiment, a totally-soluble mannan oligosaccharide extract may be provided. Totally-soluble mannan oligosaccharides may be present in a concentrated extract at about 60 to about 95 percent, about 70 to about 90 percent, or about 80 to about 88 percent by weight of the concentrated mannan oligosaccharide extract, with the remaining portion of the concentrate composed of yeast cell wall constituents.

In some embodiments, the soluble mannan oligosaccharides may be phosphorylated. Addition of one or multiple phosphate groups to each mannan oligosaccharide molecule may improve its bacterial binding capacity.

Starter feeds may include components that are nutritious for, and palatable, to young animals and may help young animals eat well. Starter feeds may be solid, rather than liquid, feeds. These solid feeds are characterized as dry feeds but may contain some amount of moisture, such as about 3 to about 15 weight percent on an as-is basis. Semi-moist starter feeds, having about 15 to about 30 weight percent moisture, may also be used.

The components of starter feeds may be species-specific. For example, a calf starter feed may include a mixture of one or more of corn, soybean meal, wheat middlings, oats, molasses, fat, ground cotton seed hulls, distillers grains, calcium carbonate, salt, and macronutrients and micronutrients. As another example, a chick starter feed may include a mixture of one or more of corn, soybean meal, oats, alfalfa, fish meal, meat meal, milo, barley, wheat, rice, wheat bran, rice bran, vitamins and minerals. A chick starter feed may also include one or more calcium sources such as aragonite, ground limestone, marble, and oyster shells.

The nutrient profile of starter feeds generally includes at least protein, fat, and fiber. The protein content in a starter feed may range from about 16 to about 22 weight percent of the starter feed. The fat content may range from about 1 to about 6 weight percent of the starter feed. The fiber content may range from about 5 to about 14 weight percent of the starter feed.

A calf starter feed may contain about 45 to 50 percent coarse ingredients such as corn, soy and oats; about 16-22 percent protein; about 2 to 3 percent fat; about 5 to 6 percent fiber (determined on a NIR basis); about 7 percent acid detergent fiber; about 6 percent molasses; and the balance including a mixture of other nutrients. Known calf starter feeds are free of soluble mannan oligosaccharides.

A chick starter feed may include at least 16 percent crude protein, at least 3 percent crude fat, at least 5 percent crude fiber, about 0.5-1 percent lysine, and the balance including a mixture of vitamins, minerals, and other nutrients. Known chick starter feeds are free of soluble mannan oligosaccharides.

A foal starter feed may include at least 16 percent crude protein, at least 6 percent crude fat, at least 7 percent crude fiber, and about 1 percent lysine, and the balance including a mixture of vitamins, minerals, and other nutrients. Known foal starter feeds are free of soluble mannan oligosaccharides.

A kid (young goat) starter feed may include at least 16 percent crude protein, at least 2.5 percent crude fat, up to 9 percent crude fiber, and the balance including a mixture of vitamins, minerals, and other nutrients. Known kid starter feeds do not include soluble mannan oligosaccharides.

A lamb starter feed may include at least 16 percent crude protein, at least 3 percent crude fat, up to 14 percent crude fiber, up to 8 percent non-protein nitrogen, and the balance including a mixture of vitamins, minerals, and other nutrients. Known lamb starter feeds are free of soluble mannan oligosaccharides.

A piglet starter feed may include at least 16 percent crude protein, at least 3 percent crude fat, up to 4 percent crude fiber, and the balance including a mixture of vitamins, minerals, and other nutrients. Known piglet starter feeds are free of soluble mannan oligosaccharides.

A bunny starter feed may include at least 16 percent crude protein, at least 1.4 percent crude fat, 14.5-18.5 percent crude fiber, and the balance including a mixture of vitamins, minerals, and other nutrients. Known bunny starter feeds are free of soluble mannan oligosaccharides.

The starter feed compositions may be free of certain components. For instance, the starter feed compositions of the present disclosure may be free of one or more of the described feed components or free of conventional mannan oligosaccharides in which yeast cell wall mannoprotein is exposed but still attached to yeast cell wall fractions, meaning the product does not contain any soluble mannoprotein. The recited compositions may contain various impurities, but in such amounts so as not to affect the advantageous properties of the inventive starter feed compositions.

Methods of Feeding Starter Feed Containing Soluble Mannan Oligosaccharides

Methods of feeding animals may involve feeding the animals starter feed containing soluble mannan oligosaccharides. This approach may include obtaining a soluble mannan oligosaccharide product and combining it with a starter feed just prior to feeding. Alternatively, the starter feed may contain the soluble mannan oligosaccharide.

Starter feed may be offered to the young animals on an ad libitum basis or, for young mammals, the amount of starter feed offered may be increased as the animals progress through the weaning process. As the animals continue to mature, the amount of starter feed offered may be decreased to encourage the animal to ingest forage or non-starter feed sources of nutrition such as grains or other feed premixes.

The amount of soluble mannan oligosaccharides fed to and available for consumption by the young animals is based on the animal's size, health status, age, and activity level. For instance, the amount of mannan oligosaccharides may be increased if the animal exhibits symptoms of gastrointestinal disease. Alternatively, the amount of mannan oligosaccharides may be decreased as the animal ages and develops a mature intestinal microflora. In other embodiments, a young animal may be fed about 0.01 to about 5 grams, about 0.01 to about 4 grams, about 0.01 to about 3 grams, about 0.01 to about 2 grams, about 0.01 to about 1 gram, about 0.01 to about 0.75 gram, about 0.01 to about 0.5 grams, about 0.01 to about 0.25 gram, about 0.5 to about 5 grams, about 1 to about 5 grams, or about 2 to about 5 grams of soluble mannan oligosaccharide per day.

In some embodiments, one or more antibiotics may also be provided to the animals concurrently with the starter feed comprising soluble mannan oligosaccharides. In some embodiments, such as for piglet starter feed, antibiotics may be provided to the animals (piglets) as a component of the starter feed comprising soluble mannan oligosaccharides. Antibiotics may be employed in response to animals exhibiting acute disease symptoms. Antibiotics may also be provided in response to the detection of specific strains of bacteria present within an animal's digestive tract.

Ingestion of starter feed containing soluble mannan oligosaccharides by young animals according to the present disclosure has been found to improve performance by the young animals. For instance, young animals may increase weight gain, may increase a rate of weight gain, may increase intake of starter feed, and/or may decrease a feed-to-gain ratio such that less feed is consumed to increase weight gain. For milk-producing livestock, improved performance may result in reduction of the age of freshening or the onset of lactation, thereby reducing the cost of milk production. For livestock sources of other animal products, such as eggs, poultry, or beef, improved performance may cause the animal to increase weight gain from early age, which may reduce the cost of, for example, egg, poultry, or beef production. Ingestion of starter feed containing soluble mannan oligosaccharides by young animals according to the present disclosure has also been found to decrease mortality rates.

In various embodiments, ingestion of soluble mannan oligosaccharides may result in sequestration of various species of bacteria, including but not limited to, Escherichia coli, Staphylococcus aureus, and/or various species of Pseudomonas, Salmonella, Shigella, and Vibrio. When bound by soluble mannan oligosaccharides, these bacteria cannot multiply and are starved to death.

In some examples, the young animal ingesting the soluble mannan oligosaccharides may be a first animal or group of animals, which exhibits improved performance as compared to a second young animal or group of animals fed identically as the first animal, with the exception that feed provided to the second animal or group of animals is free of soluble mannan oligosaccharides, the first animal and the second animal or group of animals substantially identical to each other. Animals that are substantially identical to each other are the same species, are about the same age (e.g., with an age difference of about 0 to 7 days), have about the same starting weight (e.g., have a 1 to 2 percent difference in body weight when initially fed the compositions).

In some examples, a first calf or a group of calves that is fed starter feed containing soluble mannan oligosaccharides may exhibit improved performance, such as increased weight gain, rate of weight gain, and/or starter feed intake, and/or decreased feed-to-gain ratio and/or mortality, compared to a second calf or group of calves fed identically as the first, with the exception that starter feed provided to the second calf or group of calves is free of soluble mannan oligosaccharides, the first and the second calf or group of calves substantially identical to each other.

In other examples, a first chick or group of chicks that is fed starter feed containing soluble mannan oligosaccharides may exhibit improved performance, such as increased weight gain from early age and/or reduced mortality, compared to a second chick or group of chicks fed identically as the first, with the exception that starter feed provided to the second chick or group of chicks is free of soluble mannan oligosaccharides, the first and the second chick or group of chicks substantially identical to each other.

In some examples, a first foal or group of foals that is fed starter feed containing soluble mannan oligosaccharides and may exhibit improved performance, such as increased weight gain, rate of weight gain, and/or starter feed intake, and/or decreased feed-to-gain ratio and/or mortality, compared to a second foal or group of foals fed identically as the first, with the exception that starter feed provided to the second foal or group of foals is free of soluble mannan oligosaccharides, the first and the second foal or group of foals substantially identical to each other.

In some examples, a first kid (young goat) or group of kids (young goats) that is fed starter feed containing soluble mannan oligosaccharides may exhibit improved performance, such as increased weight gain, rate of weight gain, and/or starter feed intake, and/or decreased feed-to-gain ratio and/or mortality, compared to a second kid or group of kids fed identically as the first, with the exception that starter feed provided to the second kid or group of kids is free of soluble mannan oligosaccharides, the first and the second kid or group of kids substantially identical to each other.

In some examples, a first lamb or group of lambs that is fed starter feed containing soluble mannan oligosaccharides may exhibit improved performance, such as increased weight gain, rate of weight gain, and/or starter feed intake, and/or decreased feed-to-gain ratio and/or mortality, compared to a second lamb or group of lambs fed identically as the first, with the exception that starter feed provided to the second lamb or group of lambs is free of soluble mannan oligosaccharides, the first and the second lamb or group of lambs substantially identical to each other.

In some examples, a first piglet or group of piglets that is fed starter feed containing soluble mannan oligosaccharides may exhibit improved performance, such as increased weight gain, rate of weight gain, and/or starter feed intake, and/or decreased feed-to-gain ratio and/or mortality, compared to a second piglet or group of piglets fed identically as the first, with the exception that starter feed provided to the second piglet or group of piglets is free of soluble mannan oligosaccharides, the first and the second piglet or group of piglets substantially identical to each other.

In some examples, a first bunny or group of bunnies that is fed starter feed containing soluble mannan oligosaccharides may exhibit improved performance, such as increased weight gain, rate of weight gain, and/or starter feed intake, and/or decreased feed-to-gain ratio and/or mortality, compared to a second bunny or group of bunnies fed identically as the first, with the exception that starter feed provided to the second bunny or group of bunnies is free of soluble mannan oligosaccharides, the first and the second bunny or group of bunnies substantially identical to each other.

In further examples, and with respect to a first young animal or a group of young animals fed soluble mannan oligosaccharides compared to a second young animal or group of animals fed conventional mannan oligosaccharides, animal performance by the first may be improved be about the same as animal performance of animals fed conventional mannan oligosaccharides at double the inclusion rate. Consequently, feeding soluble mannan oligosaccharides provides an improved approach to feeding the young animals conventional mannan oligosaccharides.

Implementations of the present disclosure are more particularly described in the following chick trial that is for illustrative purposes only. Numerous modifications and variations are within the scope of the present disclosure as will be apparent to those skilled in the art.

### Example

Chick Trial

This study was conducted to assess the ability of soluble mannan oligosaccharide products to improve chick performance. Measured performance parameters included weight gain, starter feed consumption, and death. By measuring the effects of mannan oligosaccharides at various solubility levels, this study revealed the significant improvement in gastrointestinal health that may be achieved by feeding chicks according to the methods disclosed herein.

One hundred eight (108) two-day-old cross broiler chicks were sourced from a commercial hatchery and treated according to standard receiving protocol at a study site in Eastern Missouri. Upon arrival, each chick was randomly assigned to 1 of 18 Petersime battery pens such that each pen housed 6 chicks. One of 3 experimental diets was randomly assigned to each pen such that each diet was provided in a total of 6 pens to a total of 36 chicks.

All 3 experimental diets included a standard corn/soybean meal starter feed having 16% protein by weight. One diet included the starter feed without any mannan oligosaccharide (“Control”). A second diet included the starter feed with 2 pounds per ton of Fulfill (Safmannan, Inc., Quincy, Ill.), a conventional mannan oligosaccharide (“Conv MOS”) in which yeast cell wall mannoprotein is exposed but still attached to yeast cell wall fractions. A third diet included the starter feed with 1 pound per ton of a completely soluble mannan oligosaccharide (“Sol MOS”). The completely soluble mannan oligosaccharide was produced by Kerry Agribusiness (Charleville, Ireland). All diets were fed ad libitum throughout the 3-week trial.

The conventional and soluble mannan oligosaccharide product each included 46% mannoprotein. The conventional mannan oligosaccharide product did not contain any soluble mannoprotein. All of the mannoprotein in the soluble mannan oligosaccharide product was soluble.

Performance data for chicks fed control starter feed and starter feed supplemented with conventional or completely soluble mannan oligosaccharide products is presented in Table 1.

TABLE 1

| | | | Comparison (P-value) | | |
|---|---|---|---|---|---|
| Treatment | | | Control v. | Control v. | Conv MOS |
| Control | Conv MOS | Sol MOS | Conv MOS | Sol MOS | v. Sol MOS |

Weight (g/hd)

| | | | | | | |
|---|---|---|---|---|---|---|
| Start | 32.68 | 33.34 | 32.85 | 0.153 | 0.620 | 0.159 |
| Week 1 | 156.69 | 149.95 | 148.14 | 0.398 | 0.205 | 0.787 |
| Week 2 | 431.26 | 427.94 | 417.52 | 0.823 | 0.556 | 0.655 |
| Week 3 | 713.26 | 844.57 | 829.87 | 0.074 | 0.061 | 0.802 |

Average Period Weight Gain (g/hd)

| | | | | | | |
|---|---|---|---|---|---|---|
| Week 1 | 124.02 | 116.60 | 115.30 | 0.360 | 0.190 | 0.840 |
| Week 2 | 274.57 | 277.99 | 269.37 | 0.922 | 0.812 | 0.694 |
| Week 3 | 282.00 | 416.63 | 412.35 | 0.045 | 0.033 | 0.939 |
| Total | 650.58 | 811.23 | 797.02 | 0.074 | 0.061 | 0.808 |

Average Period Starter Feed Intake (g/hd)

| | | | | | | |
|---|---|---|---|---|---|---|
| Week 1 | 159.00 | 144.74 | 140.37 | 0.153 | 0.067 | 0.649 |
| Week 2 | 410.12 | 412.55 | 396.9 | 0.771 | 0.577 | 0.509 |
| Week 3 | 442.15 | 513.19 | 481.85 | 0.373 | 0.431 | 0.532 |
| Total | 1011.27 | 1070.48 | 1019.11 | 0.644 | 0.909 | 0.459 |

Average Feed: Gain (g)

| | | | | | | |
|---|---|---|---|---|---|---|
| Week 1 | 1.29 | 1.24 | 1.22 | 0.630 | 0.348 | 0.712 |
| Week 2 | 1.50 | 1.50 | 1.48 | 0.938 | 0.738 | 0.791 |
| Week 3 | 1.75 | 1.27 | 1.16 | 0.030 | 0.013 | 0.624 |
| Total | 1.50 | 1.33 | 1.28 | 0.026 | 0.011 | 0.529 |

Death Loss (%)

| | | | | | | |
|---|---|---|---|---|---|---|
| Total | 19.44 | 8.33 | 11.11 | 0.344 | 0.326 | 0.691 |

The data in Table 1 demonstrate that each of the three-week weight gain and total weight gain for chicks fed starter feed with soluble mannan oligosaccharides was significantly increased (P=0.033 and 0.061, respectively) compared to chicks fed starter feed without mannan oligosaccharides. The three-week weight gain of chicks fed starter feed with soluble mannan oligosaccharides was increased 46% over the three-week weight gain of chicks fed starter feed without mannan oligosaccharides. The total weight gain of chicks fed starter feed with soluble mannan oligosaccharides was increased 23% over the total weight gain of chicks fed starter feed without mannan oligosaccharides.

The data in Table 1 demonstrate that each of the three-week feed efficiency (feed:gain ratio) and total feed efficiency for chicks fed starter feed with soluble mannan oligosaccharides was significantly increased (P=0.013 and 0.011, respectively) compared to chicks fed starter feed without mannan oligosaccharides. The three-week feed efficiency of chicks fed starter feed with soluble mannan oligosaccharides decreased (improved) 34% over the three-week feed efficiency of chicks fed starter feed without mannan oligosaccharides. The total feed efficiency of chicks fed starter feed with soluble mannan oligosaccharides decreased (improved) by 15% over the total feed efficiency of chicks fed starter feed without mannan oligosaccharides.

No significant difference in feed intake was observed between chicks fed starter feed with soluble mannan oligosaccharides compared to chicks fed starter feed without mannan oligosaccharides (P>0.9). This data suggest that the observed increased weight gain was generally attributable to increased feed efficiency, not from increased feed consumption.

As shown in Table 1, death loss was numerically improved for chicks fed starter feed with soluble mannan oligosaccharides compared to chicks fed starter feed without mannan oligosaccharides.

The data in Table 1 demonstrate soluble mannan oligosaccharides performed comparably (P>0.08) to double the amount of conventional mannan oligosaccharides. Feed efficiency of chicks fed starter feed with soluble mannan oligosaccharides was numerically improved compared to chicks fed starter feed without mannan oligosaccharides.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of feeding young livestock animals, the method comprising:
feeding the animals a starter feed, the starter feed being a solid feed and comprising an amount of mannan oligosaccharides,
wherein the mannan oligosaccharides are soluble.

2. The method of claim 1, wherein in response to ingesting the starter feed, the livestock animals increase a rate of weight gain.

3. The method of claim 1, wherein in response to ingesting the starter feed, the livestock animals increase feed efficiency.

4. The method of claim 1, wherein in response to ingesting the starter feed, the livestock animals gain weight faster than livestock animals fed the same starter feed but which is free of soluble mannan oligosaccharides.

5. The method of claim 1, wherein in response to ingesting the starter feed, the livestock animals have higher feed efficiency than livestock animals fed the same starter feed free of soluble mannan oligosaccharides.

6. The method of claim 1, wherein in response to ingesting the starter feed, fewer livestock animals die compared to livestock animals fed the same starter feed free of soluble mannan oligosaccharides.

7. The method of claim 1, wherein the livestock animals are chicks.

8. The method of claim 7, wherein mannan oligosaccharides are present in the starter feed at about 0.01 to about 1.0 percent.

9. The method of claim 7, wherein the chicks consume between about 0.01 to about 1 gram of the soluble mannan oligosaccharides per day.

10. The method of claim 7, wherein the chicks consume about 0.5 to about 1.5 grams of starter feed per day.

11. The method of claim 1, wherein the mannan oligosaccharides are from yeast cell walls.

12. The method of claim 11, wherein the yeast is a species selected from a group of fungal genera including Paecilomyces, Saccharomyces, and/or Ganoderma.

13. The method of claim 1, wherein the mannan oligosaccharides are phosphorylated.

14. A method of feeding a starter feed to chicks, the starter feed comprising an amount of soluble mannan oligosaccharides,
wherein the chicks are between about 0 and about 3 weeks of age, and
wherein the chicks increase a rate of weight gain in response to ingestion of the starter feed.

15. The method of claim 14, wherein mannan oligosaccharides are present in the starter feed at about 0.01 to about 1.0 percent.

16. The method of claim 14, wherein the chicks consume between about 0.01 to about 1 gram of the soluble mannan oligosaccharides per day.

17. The method of claim 14, wherein the chicks consume about 0.5 to about 1.5 grams of starter feed per day.
